(19) United States
(12) Patent Application Publication
(10) Pub. No.: US 2022/0374896 A1
(43) Pub. Date: Nov. 24, 2022

(54) Identity, Payment and Access Control System

(71) Applicant: Mastercard Asia/Pacific PTE LTD., Singapore (SG)

(72) Inventors: Weiming MA, Singapore (SG); Phuc Duyet BUI, Singapore (SG); Dendy GUNAWAN, Singapore (SG); Srinath RAVINATHAN, Singapore (SG); Xie ZHIJIAN, Singapore (SG); Bensam JOYSON, Singapore (SG); Rasika Chandana KARUNAPALA, Queenstown (SG); Donghao HUANG, Singapore (SG); Paul KELLETT, London (GB); James David SINTON, Leigh-On-Sea (GB)

(21) Appl. No.: 17/746,589

(22) Filed: May 17, 2022

Related U.S. Application Data
(60) Provisional application No. 63/189,890, filed on May 18, 2021.

(51) Int. Cl. G06Q 20/40; G06Q 20/38; G06Q 20/36

(52) U.S. Cl. CPC G06Q 20/4014; G06Q 20/385; G06Q 20/3674

(57) ABSTRACT

Various implementations described herein are directed to a method for providing identity, payment and/or access. A primary account number (PAN) is read from a card or token. A hashed PAN is generated. A transaction result is determined based on the hashed PAN.

### CROSS-REFERENCE TO RELATED APPLICATIONS

This application claims the benefit of U.S. provisional patent application Ser. No. 63/189,890, filed May 18, 2021 and titled IDENTITY, PAYMENT AND ACCESS CONTROL SYSTEM, the entire disclosure of which is herein incorporated by reference.

### BACKGROUND

This section is intended to provide background information to facilitate a better understanding of various technologies described herein. As the section's title implies, this is a discussion of related art. That such art is related in no way implies that it is prior art. The related art may or may not be prior art. It should therefore be understood that the statements in this section are to be read in this light, and not as admissions of prior art.

Global pandemics require a reevaluation of the manner in which people interact and engage in commercial activities. Touchless experiences will be the new normal in a post-COVID world. Current solutions are not completely end-to-end and use separate tools for identity, payment and access.

### SUMMARY

Described herein are various implementations of a method for providing identity, payment and/or access. In one implementation, a primary account number (PAN) is read from a card or token. A hashed PAN is generated. A transaction result is determined based on the hashed PAN.

In one implementation, the transaction result can be determined locally.

The transaction result can be determined locally by performing an offline match of the hashed PAN against a locally stored whitelist.

In one implementation, the transaction result can be determined based on a decision made by a backend server.

The hashed PAN can be sent to the backend server and the backend server can match the received hashed PAN against a whitelist.

In one implementation, the PAN can be read from a contactless card.

In one implementation, the PAN can be read via a token provided by a digital wallet present on a mobile device.

In one implementation, the PAN can be read via a token provided by a digital wallet accessible via a wearable device

In one implementation, the PAN can be read using a select proximity payment system environment (PPSE) command to ensure that PANs from a particular payment processor are read.

Described herein are various implementations of a method for providing identity, payment and/or access. In one implementation, a zero dollar transaction is initiated with a card or token. A primary account number (PAN) is determined from information received via the zero dollar transaction. The card or token is authenticated. A hashed PAN is generated. A transaction result is determined based on the hashed PAN.

In one implementation, the card or token can be authenticated using CDA.

In one implementation, the transaction result can be determined locally.

The transaction result can be determined locally by performing an offline match of the hashed PAN against a locally stored whitelist.

In one implementation, the transaction result can be determined based on a decision made by a backend server.

The hashed PAN can be sent to the backend server and the backend server can matches the received hashed PAN against a whitelist.

In one implementation, the transaction data can be provided to a server in real-time.

In one implementation, the transaction data includes application transaction counter (ATC) data.

In one implementation, the zero dollar transaction can be initiated with a contactless card.

In one implementation, the zero dollar transaction can be initiated with a digital wallet present on a mobile device.

In one implementation, the zero dollar transaction can be initiated with a token provided by a digital wallet accessible via a wearable device.

Described herein are various implementations of a method for providing identity, payment and/or access. In one implementation, an access identifier (ID) or primary account reference (PAR) is read from a card or token. A transaction result is determined locally or via a server based on the access ID or PAR.

In one implementation, the transaction result is determined by matching the access ID or PAR against a whitelist.

The above referenced summary section is provided to introduce a selection of concepts in a simplified form that are further described below in the detailed description section. Additional concepts and various other implementations are also described in the detailed description. The summary is not intended to identify key features or essential features of the claimed subject matter, nor is it intended to be used to limit the scope of the claimed subject matter, nor is it intended to limit the number of inventions described herein. Furthermore, the claimed subject matter is not limited to implementations that solve any or all disadvantages noted in any part of this disclosure.

### BRIEF DESCRIPTION OF THE DRAWINGS

Implementations of various techniques will hereafter be described with reference to the accompanying drawings. It should be understood, however, that the accompanying drawings illustrate only the various implementations described herein and are not meant to limit the scope of various techniques described herein.

FIG. 1 illustrates a system for providing identity, payment and access services in accordance with implementations of various techniques described herein.

FIG. 2 illustrates a diagram of a system having service providers and identifier providers in accordance with implementations of various techniques described herein.

FIG. 3 illustrates a diagram of a system for generating a hashed primary account number (PAN) in accordance with implementations of various techniques described herein.

FIG. 4 illustrates a diagram describing categories for terminal certification for terminals working within the identity, payment and access system in accordance with implementations of various techniques described herein.

FIG. 5 illustrates a diagram of a method for providing identity, payment and access services in accordance with implementations of various techniques described herein.

FIG. 6 illustrates a diagram of a method for providing identity, payment and access services in accordance with implementations of various techniques described herein.

FIG. 7 illustrates a diagram of a system for providing access to an event in accordance with implementations of various techniques described herein.

FIG. 8 illustrates an example software data kit in accordance with implementation of various techniques described herein.

FIG. 9 illustrates an example object for reading an outcome of an EMV card event in accordance with implementations of various techniques described herein.

FIG. 10 illustrates a diagram of a system for providing transit system access in accordance with implementations of various techniques described herein.

FIG. 11 illustrates a diagram of a hardware architecture of a system for providing identity, payment and access services in accordance with implementations of various techniques described herein.

FIG. 12 illustrates a diagram of an employee onboarding system using an in-office booth in accordance with implementations of various techniques described herein.

FIG. 13 illustrates a diagram of an employee onboarding method using a user's near field chip (NFC) enabled mobile device in accordance with implementations of various techniques described herein.

FIG. 14 illustrates a diagram of a system for providing employee onboarding and employee access in accordance with implementations of various techniques described herein.

FIG. 15 illustrates a diagram of a high-level view of an identity, payment and access system in accordance with implementations of various techniques described herein.

FIG. 16 illustrates a computing system in accordance with implementations of various techniques described herein.

FIG. 17 illustrates a diagram describing categories for terminal certification for terminals working within the identity, payment and access system in accordance with implementations of various techniques described herein.

FIG. 18 illustrates an example object for reading an access identifier in accordance with implementations of various techniques described herein.

FIG. 19 illustrates a diagram of a method for providing identity, payment and access services in accordance with implementations of various techniques described herein.

### DETAILED DESCRIPTION

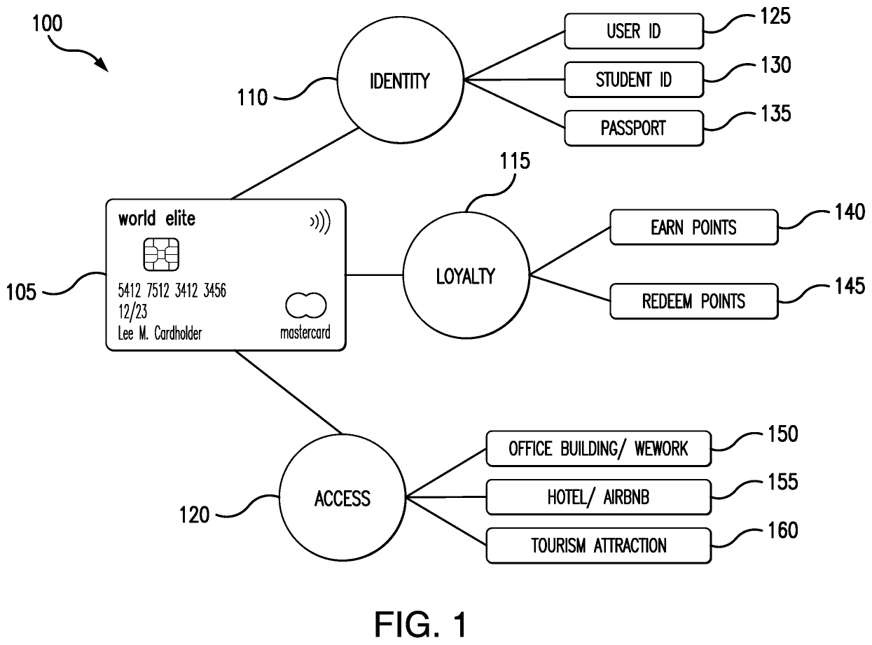

FIG. 1 illustrates a system 100 for providing identity, payment and access services. Europay, Mastercard, Visa (EMV) is a payment technology standard for providing secure transactions. An EMV card or chip card is a device that includes an embedded secure integrated circuit that can be either a secure microcontroller or equivalent intelligence with internal memory or a secure memory chip alone. The card connects to a reader with direct physical contact or with a remote contactless radio frequency interface, e.g., near field communication (NFC). With an embedded microcontroller, chip cards have the unique ability to securely store large amounts of data, carry out their own on-card functions (e.g., encryption and mutual authentication) and interact intelligently with a card reader. All EMV cards are chip cards. Chip cards can be plastic or metal cards having an embedded chip that communicates information to a payment or automated teller machine (ATM) terminal. Chip cards offer increased security.

System 100 includes implementations that are designed to enable cardholders to use any EMV contactless card or token to easily access value-added services, such as identification, loyalty and access in various use cases such as retail, smart cities, travel & hospitality.

The present system provides end-to-end implementations for identity 110, loyalty programs 115 and access 120 using the EMV standard 105 via, for example, contactless cards, tokens, mobile device digital wallet, wearable devices coupled to mobile devices. Examples related to identity 110 include passports 135, student identification 130 and user identification 125. Examples related to loyalty 115 include earning points 140 and redeeming points 145. Examples related to access include office building and/or wework systems 150, hotels and other types of rental properties 155, and attractions 160, e.g., tourism, sports or other activities. The present system brings an end-to-end, seamless touchless experience by unlocking hidden potential in existing contactless cards/tokens.

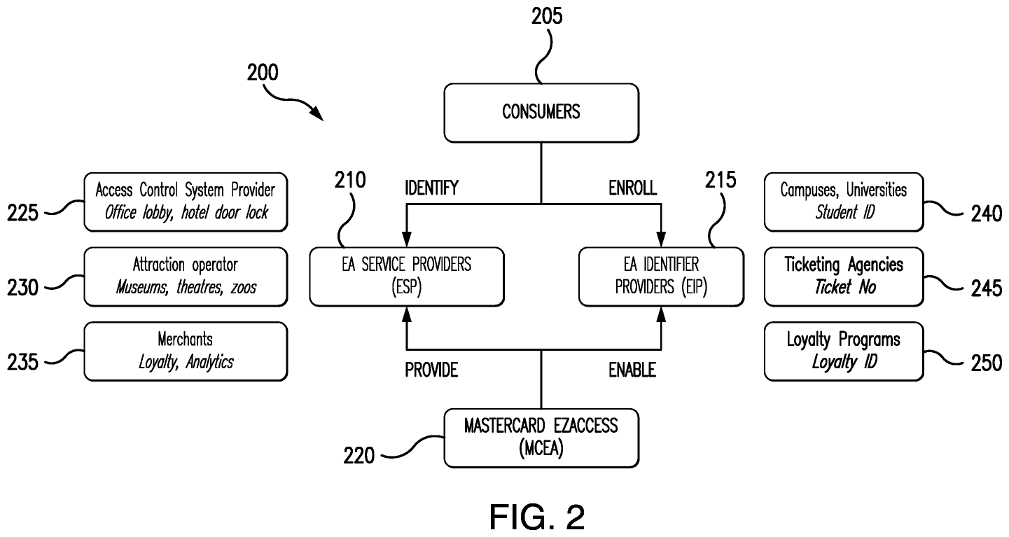

FIG. 2 illustrates a diagram of a system 200 having service providers and identifier providers. A consumer 205 identifies with a service provider 210 or enrolls with an identifier provider 215. Access server 220 provides service provider 210 with the ability to implement services, e.g., access control 225, entrance to attractions 230 and merchant services 235. Access control 225 system providers may include office lobbies, hotels, door locks. Attractions 230 may include museums, theatres, zoos, or any other type of attraction. Merchant services 235 may include loyalty and analytics programs. Access server 220 enables identifier provider 215 to provide student identification 240, ticketing, 245 and loyalty identification 250 services.

In one implementation, when a consumer uses an EMV card, token, or digital wallet having an associated payment card number or primary account number (PAN), the access server 220 matches the loyalty program identifier of the consumer with the PAN of the consumer. In other words, the access server maps/binds the loyalty program identifier to the PAN of the consumer.

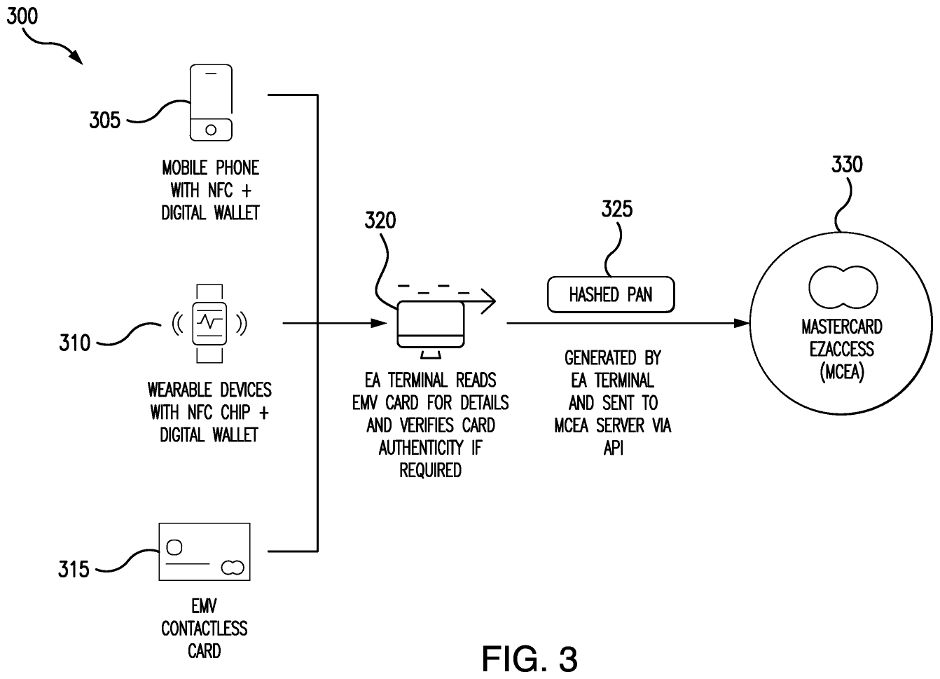

FIG. 3 illustrates a diagram of a system 300 for generating a hashed PAN. Payment card information may be presented in three ways: via a mobile device 305, a wearable device 310 or a contactless EMV card 315. Mobile device 305 may include near field communication (NFC) circuitry and digital wallet software. The digital wallet is a software-based system that securely stores users' payment information and passwords for various payment methods and websites. By using a digital wallet, users can complete purchases easily and quickly, for example, with near-field communications technology. Wearable device 310 may also include NFC circuitry and digital wallet software. Terminal 320 reads EMV card information from EMV card 315 or via the digital wallet of mobile device 305 or wearable device 310. Terminal 320 determines the PAN from the EMV card or receives the PAN from the digital wallet of the mobile device or wearable device. In one implementation, terminal 320 verifies card authenticity. Terminal 320 generates a hashed PAN and sends the hashed PAN to the access server 330.

In one implementation, a hashed PAN or digital account number (DAN) is generated using the following method. Salt is provisioned to the terminal 320 by the access server 330. The PAN/DAN is read from the EMV card or token. A salt is random data that is used as an additional input to a one-way function that hashes data, a password or passphrase. Salts are used to safeguard PANs/DANs. A new salt is randomly generated for each PAN/DAN. In one implementation, the salt and the PAN/DAN (or a version of the PAN/DAN) are concatenated and fed to a cryptographic hash function. The hashed PAN/DAN, e.g., output hash value, (but not the original PAN/DAN) can be stored in a local memory or sent to access server 330. Hashing allows for later authentication without keeping and therefore risking exposure of the PAN/DAN if the authentication data store is compromised. In one implementation, the PAN/DAN read by terminal 320 can be 13 to 19 digits. In one implementation, the hashed PAN (PAN|SALT) or hashed DAN (DAN|SALT) can be generated by a SHA256 hash function. For the sake of simplicity, wherever the present disclosure describes implementations related to a PAN, the same methods described herein can be applied to DANs and/or tokens presented by mobile and/or wearable devices.

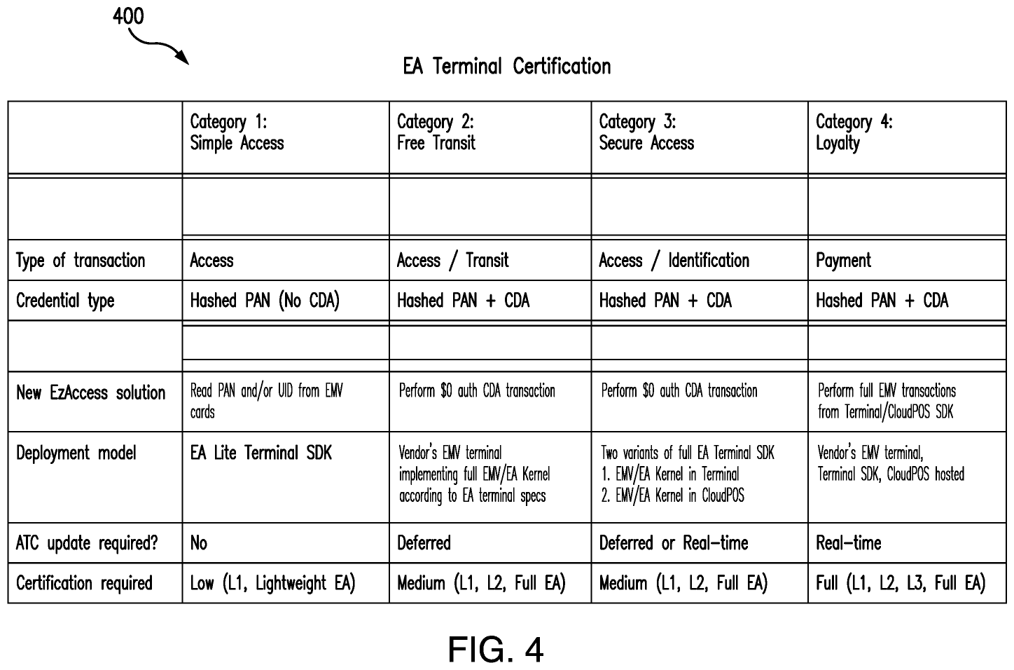

FIG. 4 illustrates a diagram 400 describing four categories for terminal certification for terminals, e.g., terminal 320, working within the identity, payment and access system 100. The terminals are categorized according to the type of transaction, the credential type, the type of solution provided, deployment model version, whether an ATC update is performed, and the type of certification that is performed. Category 1 terminals provide simple access. Category 2 terminals can be used in free transit systems. Category 3 terminals can be used to provide secure access and category 4 terminals can be used to provide loyalty programs.

A Category 1 terminal is provided for simple access. The credential type for this type of system is a hashed PAN. In this implementation combined dynamic data authentication-application cryptogram generation (CDA) is not necessary. In this implementation, the terminal, e.g., terminal 320, reads the PAN and/or user identifier (UID) from the EMV card, mobile device or wearable device and provides access. Access can be provided by matching the hashed PAN locally or upon verification by a remote access server, e.g., access server 330. The terminal can be provided using a software data kit (SDK), no application transaction counter (ATC) update is required, and the certification requirements for the terminal are low. An ATC is a counter maintained by the EMV card or digital wallet application that provides a sequential reference to each transaction. The ATC is a sequential counter managed by the contactless card or token that is used to ensure that all cryptograms produced are unique. A duplicate ATC, a decrease in ATC or a large jump in ATC values may indicate data copying or other fraud to an issuer.

A Category 2 terminal is provided for access and/or transit systems. The credential for this type of system is a hashed PAN and CDA. CDA, which is also referred to as combined data authentication, involves including the card decision among the data being signed by the card's RSA key (public key or asymmetric key algorithm). In this implementation, the terminal, e.g., terminal 320, performs a zero dollar ($0) authorization CDA transaction. The vendor's terminal is an EMV terminal implementing full EMV access kernel according to access terminal specifications. In this implementation, ATC updates can be deferred and certification requirements are medium.

A Category 3 terminal is provided for secure access systems. Secure access systems can be directed to access and/or identification systems The credential for this type of system is a hashed PAN and CDA. In this implementation, the terminal, e.g., terminal 320, performs a zero dollar ($0) authorization CDA transaction. The vendor's terminal SDK can be one of two types. The first terminal type for this implementation is an EMV terminal implementing a full EMV access kernel according to access terminal specifications. The second terminal type is an SDK communicating with an EMV access kernel implemented in a cloud point of sale (POS) server. In this implementation, ATC updates can be deferred or provided in real-time and certification requirements are medium.

A Category 4 terminal is provided for loyalty systems. Loyalty systems can be directed to merchant retail stores and/or payments. The credential for this type of system is a hashed PAN and CDA. In this implementation, the terminal, e.g., terminal 320, performs full EMV transactions from the terminal and/or cloud POS SDK. The vendor's terminal can include a terminal SDK or be hosted by a cloud POS server. In this implementation, ATC updates are provided in real-time and full certification is required.

In one implementation, the terminal reads PAN numbers by using SELECT PPSE and READ RECORD command, e.g., for Category 1 transactions. In this implementation, a get processing options (GPO) command is not issued. This implementation, while simpler to implement, is less secure and subject to card cloning or emulation.

In one implementation, the terminal performs CDA with a GPO command, which will increase the ATC. In this implementation, the access server sends ATC updates to the issuer. This implementation is more secure and ensures that the card/token is genuine.

In one implementation a Cloud POS server can be leveraged to implement an EMV/EA Kernel for some use cases to reduce the terminal upgrade efforts.

In one implementation NFC data exchange performed by a terminal can be modified to perform a READ RECORD followed by a GPO. This implementation enables a single-tap hashed PAN reading mode for loyalty systems.

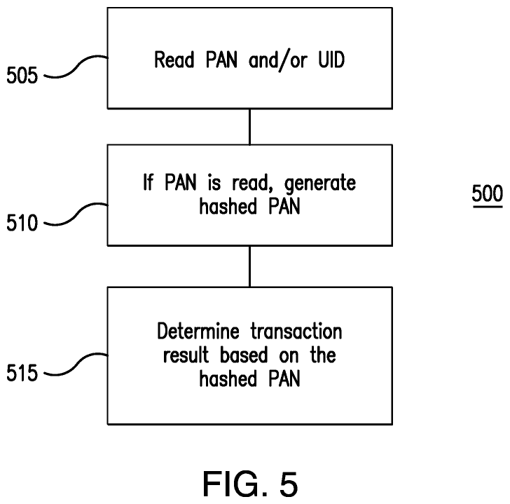

FIG. 5 illustrates a diagram of a method 500 for providing identity, payment and access services. At block 505, a PAN and/or UID is read by the terminal, e.g., terminal 320. The PAN and/or UID may be read from a contactless card or via a token provided by a digital wallet present on a mobile device (or accessible via a wearable device communicatively coupled to the mobile device). At block 510, if a PAN is read, the terminal generates a hashed PAN. At block 515, the terminal determines a transaction result based on the hashed PAN. In one implementation, the transaction result is determined locally. In one implementation, the transaction result is based on a decision made by an access server, e.g., access server 330. In one implementation, the transaction result is determined by performing an offline match of hashed PAN and/or UID against a locally stored whitelist. In one implementation, terminal 320 sends the hashed PAN and/or UID to a backend server, e.g., a server between access server 330 and the terminal 320, for a decision to be determined and provided by the backend server upon matching the received hashed PAN against a whitelist. In one implementation, the service provider, e.g., the provider of identity, payment and/or access services, can optionally upload, e.g., via a backend server, the transaction data from the terminal (including UID, hashed PAN and/or other pertinent data) to the access server in real-time or as soon as possible.

The card PAN can be read, for example, using select proximity payment system environment (PPSE) command to ensure that PANs/tokens from a particular payment processor are read. Once verification that a PAN/token from the particular payment processor is presented, a read record command is given read the PAN/token. The following are example select PPSE and Read Record commands:

### SELECT PPSE COMMAND: 0062011400

### READ RECORD COMMAND: 00A4040007A0000000041010

Certification for a terminal providing method 500 includes testing that the terminal can interact with the EMV card or device (mobile or wearable). Certification further includes testing to verify whether the terminal can determine that the EMV card is powered and that the flow of information can be shared. In addition, certification includes determining whether the terminal and access server can implement the transaction and data handling described in method 500.

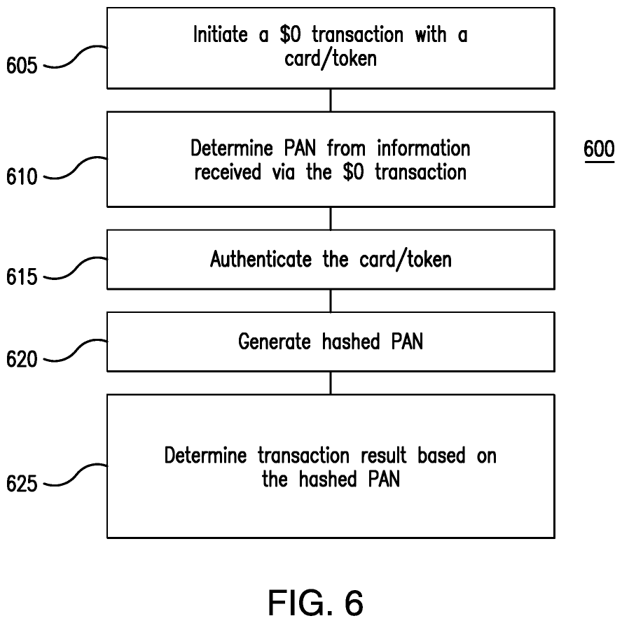

FIG. 6 illustrates a diagram of a method 600 for providing identity, payment and access services. At block 605 a $0 transaction is initiated with an EMV card or token. The EMV card may be a contactless card. Initiating a $0 transaction involves receiving a PAN and other data from the card or token. At block 610, the PAN is determined from information received via the $0 transaction. At block 615, the card/token is authenticated. In one implementation, the card/token is authenticated using CDA. CDA provides a fast and secure offline card/token authentication protocol and is supported by all contactless cards and tokens. If CDA is successful, a hashed PAN is generated at block 620. A transaction result is determined at block 625. In one implementation, the transaction result is determined locally. In this implementation, the transaction result is determined by performing an offline match of the hashed PAN against a locally stored whitelist. In another implementation, the transaction result is based on a decision made by a backend server. In this implementation, the hashed PAN is sent to the backend server for a decision on the transaction to be made by the backend server by matching the received hashed PAN against a whitelist. In one implementation, the terminal reads ATC data from the EMV card/token and provides this ATC data to the access server.

The service provider uploads, e.g., via a backend server, the transaction data from the terminal (including UID, hashed PAN and/or other pertinent data) to the access server in real-time or as soon as possible. The access server sends ATC update messages to issuers based on transaction data received from all service providers. Sending ATC updates to issuers notifies the issuer that the ATC has been incremented more than may be usual. Keeping the issuer apprised via ATC update messages avoids situations that may create unexpected declines for payment transactions.

Certification for a terminal providing method 600 includes testing that the terminal can interact with the EMV card or device (mobile or wearable). Certification further includes testing to verify whether the terminal can determine that the EMV card is powered and that the flow of information can be shared. In addition, certification includes determining whether the terminal and access server can implement the transaction and data handling described in method 600. In one implementation, an access kernel is provided. In this implementation certification includes testing to determine whether the access kernel and the card/token can communicate the correct information to allow data sharing and to allow decision-making on processing at the terminal.

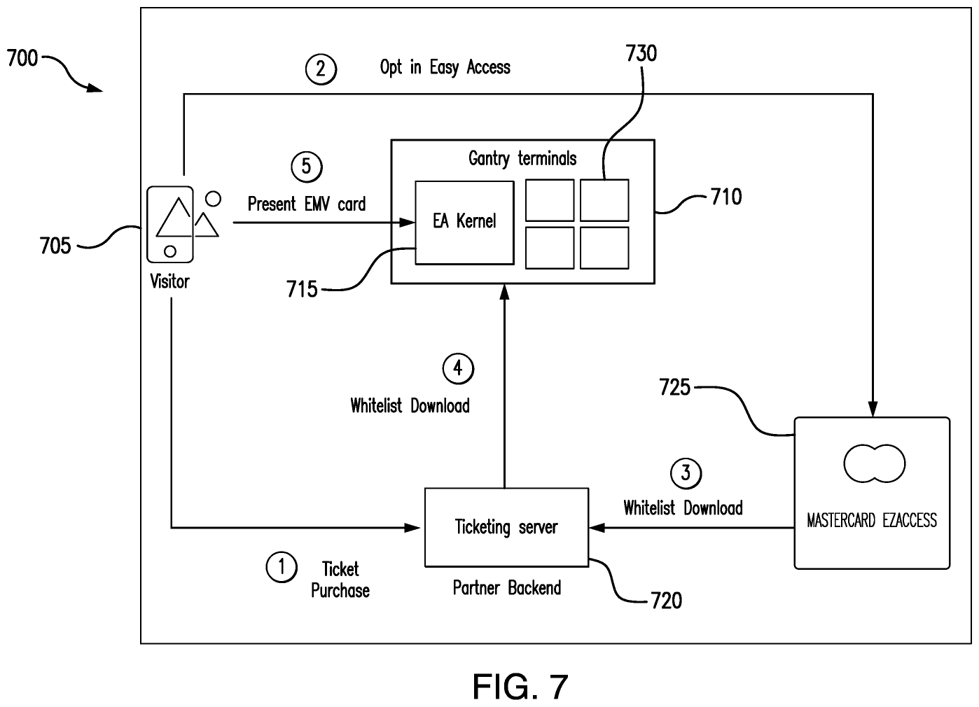

FIG. 7 is a diagram of a system 700 for providing access to an event. System 700 includes an EMV card or token 705, gantry 710 including access kernel 715 and gantry terminals 730, a backend server of a service provider, e.g., ticketing server 720, and an access server 725. At item 1, a visitor purchases a ticket via a web-based or application-based transaction from ticketing server 720. At item 2, upon purchasing the ticket, the visitor is presented with an option to use their EMV card or token 705 to gain access to the event. Upon selecting the option to use the EMV card or token 705 for the purpose of accessing the event, the user opts into the access service and the access server 725 is notified. In one implementation, the transaction details and transaction ID are sent to the user's email, and that transaction ID is embedded in the link to opt into the access service. When the link is clicked, a web page is loaded along with the transaction ID, and the user can enter additional card details, e.g., either from a physical card or from the user's digital wallet. These hashed PANs and the transaction ID are then sent to the access server 725. At item 3, the ticketing server 720 downloads a whitelist, e.g., a list of eligible hashed PANs that are associated with valid ticket booking references to ticketing server 720. At item 4, the whitelist is downloaded to gantry 710. At item 5, when the visitor presents the EMV card/token at the gantry 710, the PAN/token is read by access kernel 715. Access kernel 715 generates a hashed PAN and compares the hashed PAN to the downloaded whitelist.

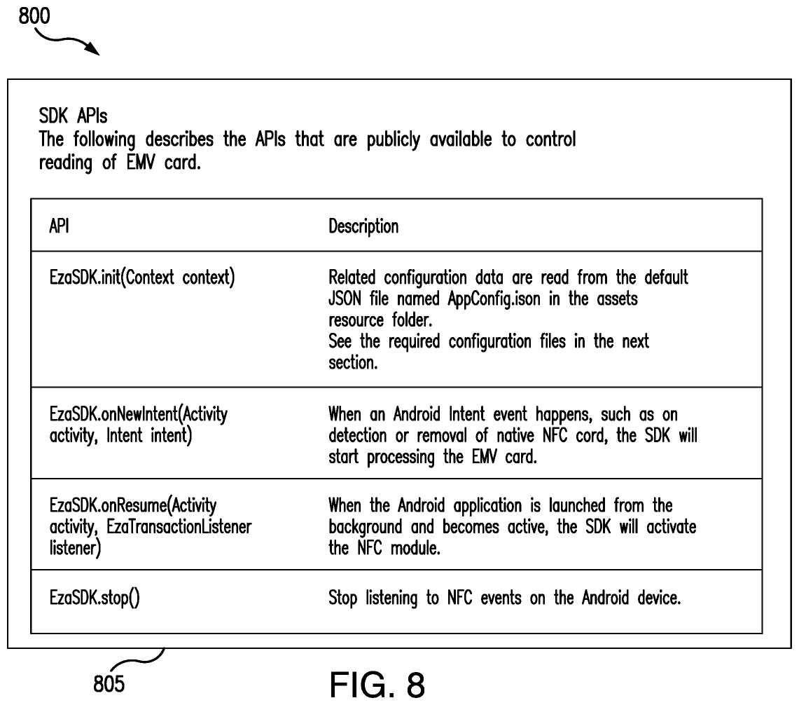

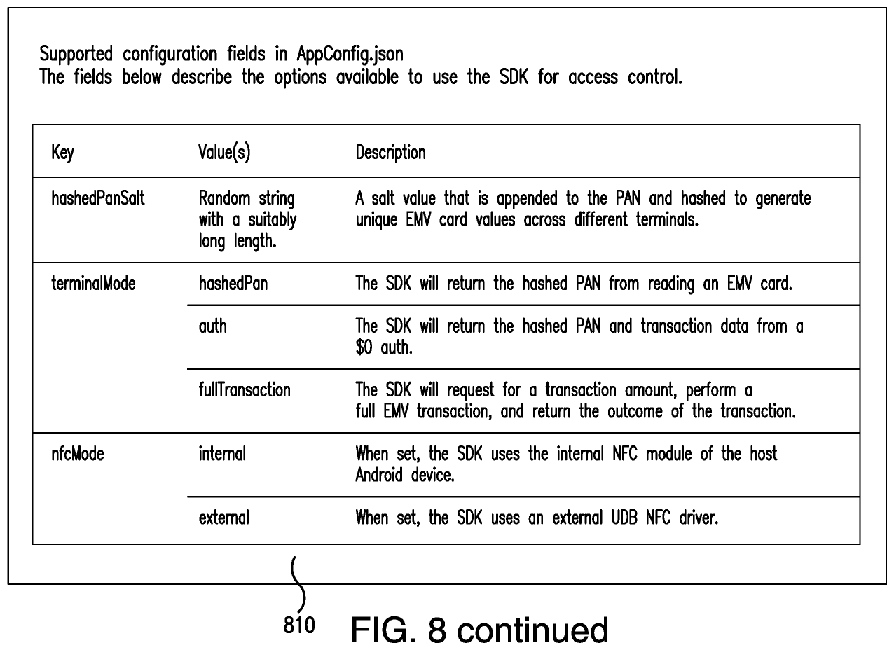

FIG. 8 shows an example SDK 800. In particular, SDK 800 can be used to implement terminal 320 and method 500. Item 805 describes application programming interfaces (APIs) that are publicly available to control the reading of an EMV card. In particular, item 805 describes the following APIs: EzaSDK.init (Context context), EzaSDK.onNewlntent (Activity activity, Intent intent), EzaSDK.onResume(Activity activity, EzaTransactionListener listener), and EzaSDK.stop( ) The EzaSDK.init(Context context) API reads related configuration data from a default JavaScript Object Notation (JSON) file named AppConfig.ison in an assets resource folder. The EzaSDK.onNewlntent(Activity activity, Intent intent) API provides that when an Android Intent event happens, such as on detection or removal of a native NFC card, the SDK will start processing the EMV card. The EzaSDK.onResume(Activity activity, EzaTransactionListener listener) API provides that when the Android application is launched from the background and becomes active, the SDK activates the NFC module. The EzaSDK.stop( ) API allows the terminal to stop listening to NFC events on an Android device.

Item 810 describes supported configuration fields in AppConfig.json. The fields in item 810 describe options available to use the SDK for access control. In one implementation, a hashedPanSalt is a random string having a suitably long length. The salt value is appended to the PAN and hashed to generate unique EMV card values across different terminals. A terminalMode field can be one of three values: a hashedPan, an auth, or a fullTransaction. When the hashedPan is used, the SDK returns the hashed PAN from reading an EMV card. When auth is used, the SDK returns the hashedPAN and transaction data from a $0 authorization. When fullTransaction is used, the SDK requests for a transaction amount, performs a full EMV transaction, and returns the outcome of the transaction. An nfcMode field can have an internal value or an external value. When the internal value is set, the SDK uses the internal NFC module of the host Android device. When the external value is set, the SDK uses an external universal serial bus (USB) NFC driver.

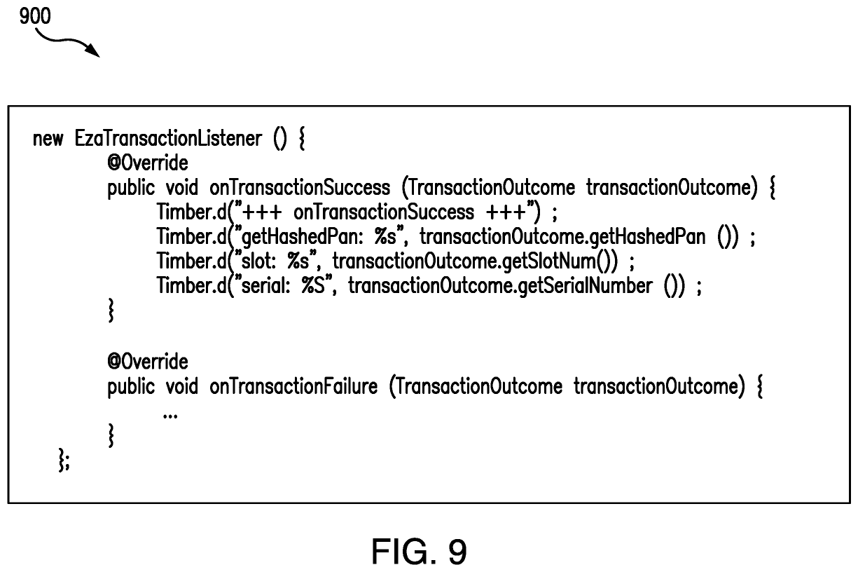

FIG. 9 illustrates an example object 900 for reading an outcome of an EMV card event. Reading the outcome of an EMV card event can be implemented by using the EzaTransactionListener according to two methods, a success or a failure. All transaction information whether a success or a failure, can be retrieved from the TransactionOutcome object.

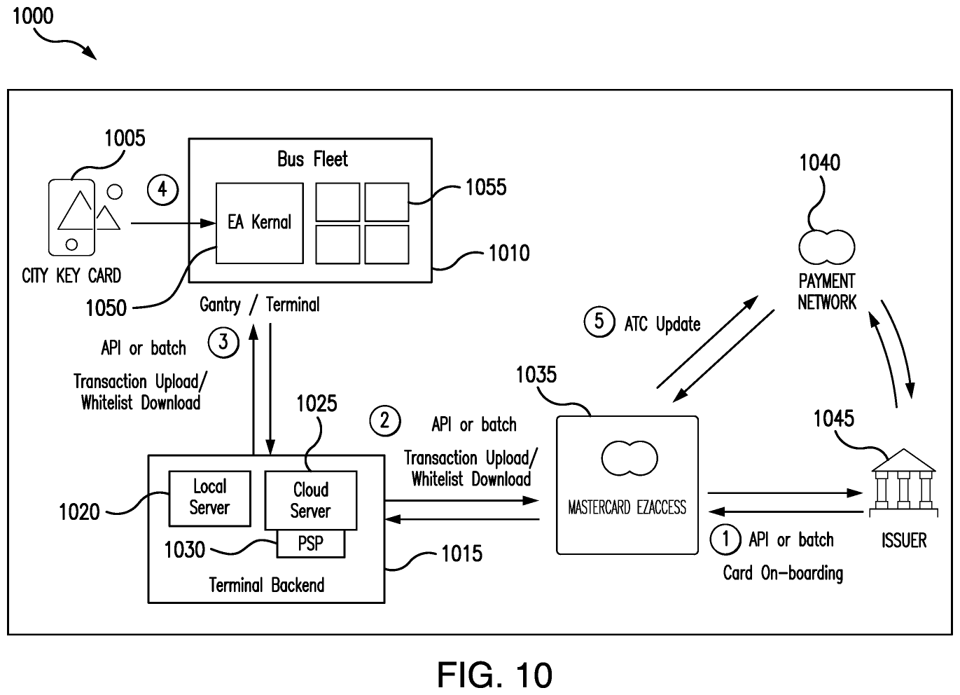

FIG. 10 is a diagram of a system 1000 for providing transit system access. System 1000 includes a transportation key card 1005, gantry/terminal 1010 coupled to one or more fleet terminals 1055 and access kernel 1050, a terminal backend 1015 of a transit system provider that includes a local server 1020, a cloud server 1025 and PL/SQL Server Pages (PSP), an access server 1035, a payment network 1040, and an issuer 1045.

At item 1, issuer 1045 onboards key cards onto access server 1035 as hashed PANs. At item 2, vendor, e.g., terminal backend 1015, downloads, from access server 1035, a list of eligible hashed PANs, e.g., a whitelist. Terminal backend 1015 also uploads transaction records to access server 1035. At item 3, when a passenger presents a transportation key card at transportation terminals, e.g., gantry 1010 or fleet terminals 1055, entry details are stored in a memory of the gantry/terminal 1010, 1055. Gantry/terminal 1010, 1055 supports internal and external expandable storage capability, e.g., SD cards. A hashed PAN is generated for the transportation key card and CDA authentication is performed to ensure that the card is genuine. In this implementation, the ATC counter is incremented. At item 4, hashed PANs are synchronized to the fleet and historical transaction data is uploaded. At item 5, access server 1035 sends ATC updates to the issuer 1045 via the payment network 1040.

The implementation of FIG. 10 describes a closed-loop platform where the transit system access provider can migrate to an open-loop platform. In closed-loop transit, fare is purchased beforehand and stored on a non-EMV card. Fare transactions are synchronized with a local server, e.g., at the end of the day. The migration to open-loop transit with EMV-enabled gantry terminals allows them to be connected to cloud servers, which are connected to a Payment Service Provider (PSP) to allow near real-time payment (or end of day) transactions. Local server 1020 supports gantry terminals in closed-loop transit, and cloud server 1025 supports open-loop transit.

In one implementation, certain hashed PANs are allowed for free transit. These hashed PANs are stored in a whitelist. The whitelist is transferred from Access Server 1035 and stored in gantry terminals 1050. During tap in at the gantry, the card transaction data is stored in the gantry terminal, but at end of day reconciliation, the card transaction data is synchronized to the backend 1015, and forwarded to Access Server 1034.

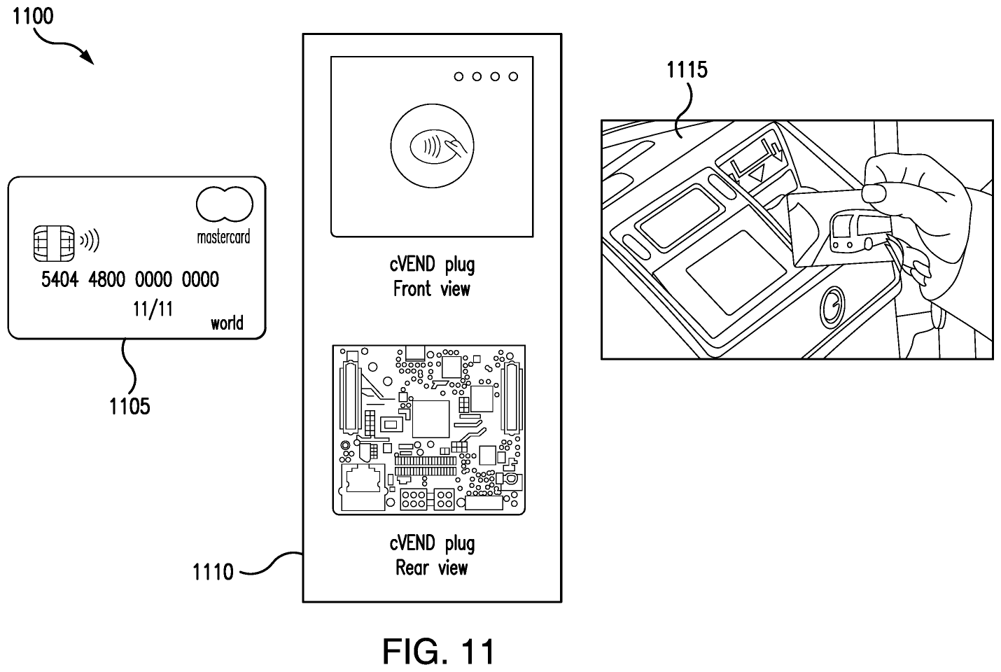

FIG. 11 is a diagram of a hardware architecture of a system 1100 for providing identity payment and access services. A card or token 1105 (via mobile and/or wearable device) is presented to a terminal 1110. Terminal 1110 can store 1 MB of 100 hashed PANs as a whitelist. In addition, terminal 1110 can send application protocol data unit (APDU) commands over any NFC to read card data. A SHA256 algorithm can be applied to the card data to determine the hashed PAN. The determined hashed PAN can be compared against the whitelist. Terminal 1110 can store card and entry details. In one implementation, terminal 1110 includes a central processing unit (CPU) memory having at least 128 MB random access memory (RAM) and 256 MB flash memory. In one implementation, removable micro secure digital (μSD) memory is supported. Item 1115 shows the hardware integration of terminal 1110 with a gantry. In this particular implementation, a sticker can be provided on the gantry to indicate that only compatible key cards can be tapped. A speaker can be provided to give feedback to passengers on approval or denial of entry. A display can also be provided to give feedback on approval or denial of entry.

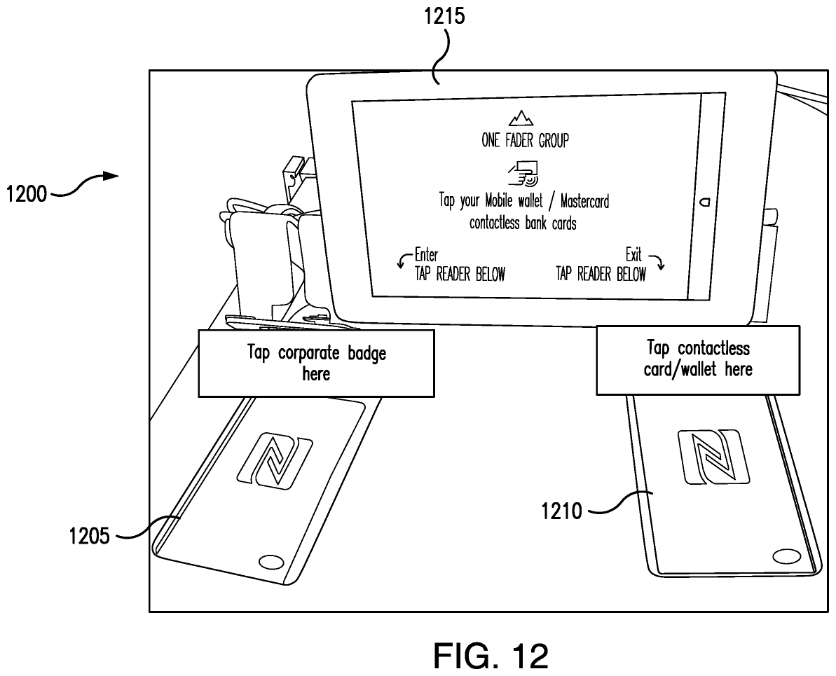

FIG. 12 is a diagram of an employee onboarding system 1200 using an in-office booth. A self-onboarding booth can be implemented at an office lobby or near a reception area. Staff members begin the onboarding process by tapping their corporate badge at a card reader 1205 coupled to a terminal 1215. The staff member would then tap their contactless physical/digital card on a second card reader 1210 to register for access. Staff may begin using their EMV card, mobile device, or wearable device, to access a building once onboarding is complete.

FIG. 13 is a diagram of an employee onboarding method 1300 using a user's NFC-enabled mobile device. At block 1305, the user accesses an employee onboarding application on their mobile device. At block 1310, the corporate badge of a user is registered when placed the near the NFC reader of the mobile device. When onboarding is complete, a notification is provided via a success screen at item 1315. The user is now able to gain access to the site using their mobile device at item 1320.

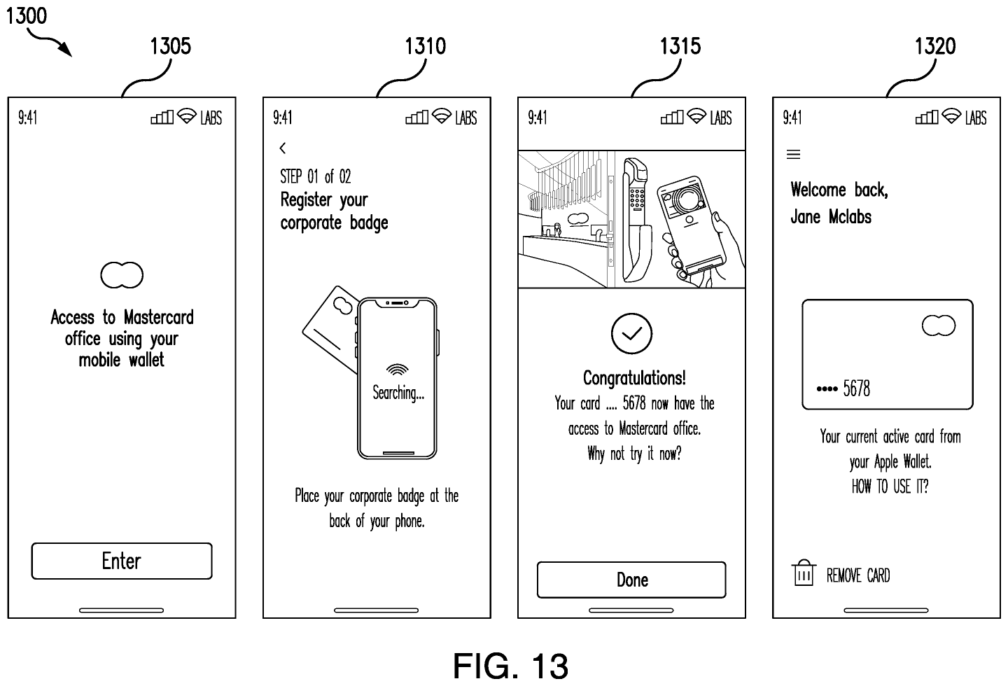

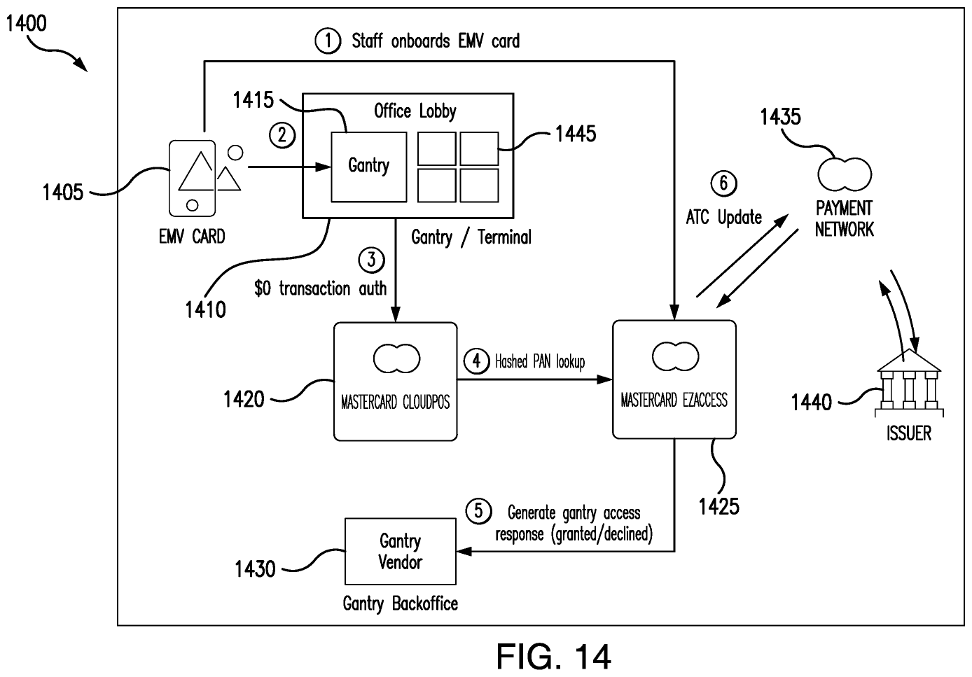

FIG. 14 is a diagram of a system 1400 for providing employee onboarding and employee access. System 1400 includes an EMV card 1405, gantry/terminal 1410 having a gantry 1415 and one or more terminals 1445, a gantry backoffice 1430, a cloud point of sale (POS) server 1420, an access server 1425, a payment network 1435, and an issuer 1440. In one implementation, the one or more terminals 1445 include terminals 1205, 1215.

At item 1, a user onboards a corporate ID badge and EMV card to access server 1425 as described in FIG. 12 or FIG. 13. At item 2, the EMV card is presented at gantry 1415. At item 3, Cloud POS 1420 initiates a $0 transaction over a secure network. At item 4, Cloud POS 1420 reads the hashed PAN from the EMV card and performs a lookup of access rules from access server 1425. At item 5, access server 1425 requests the gantry vendor, e.g. gantry backoffice 1430, to generate a gantry access response, e.g., granted or declined. The gantry access response is then sent from the gantry backoffice 1430 to the gantry terminal 1410. At item 6 transaction cryptogram data is sent to payment network 1435 to update the ATC.

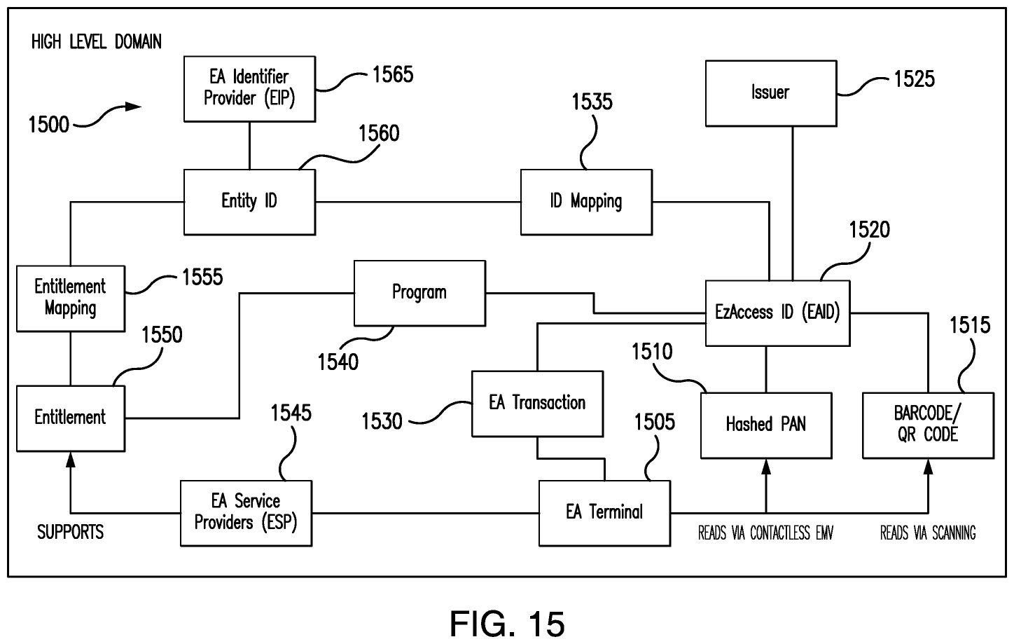

FIG. 15 is a diagram of a high-level view 1500 of the identity, payment and access system. The system uses an access ID 1520 to implement a variety of identity, loyalty and access services. The access ID 1520 is mapped to a variety of items including, but not limited to, transaction data 1530, hashed PANs 1510, Barcode and/or QR codes 1515, program data 1540 and IDs 1535. Transaction data 1530, hashed PANs 1510 and Barcodes/QR codes 1515 can be provided by a terminal 1505. Various data associated with the access ID 1520 can be provided to an issuer 1525. Service providers 1545 can provide entitlements 1550 and entitlement mapping 1555 via the use of terminal 1505. Identifier provider 1565 can provide an entity ID 1560 that is mapped 1535 to the access ID 1520 and/or entitlements 1555.

The present system provides a variety of advantages. QR codes, bar codes and vendor cards can easily be duplicated. The present disclosure provides a system that can read PAN and serial number from physical and digital EMV cards. The hardware of the present disclosure is low-cost and uses existing gantries and/or USB NFC devices. Implementations of the present disclosure are built on top of existing highly secure and proven EMV payment standards, provides a unified digital-first experience for consumers across different domains, and provides more data points for merchants.

FIG. 16 is a block diagram of a hardware configuration 1600 operable as a device in an identity, payment and access system 100. Hardware configuration 1600 may be utilized to implement one or more of elements 305, 310, 315, 320, 330, 705, 710, 715, 720, 725, 730, 1005, 1010, 1015, 1020, 1025, 1030, 1035, 1040, 1045, 1050, 1055, 1105, 1110, 1115, 1205, 1210, 1215, 1405, 1410, 1415, 1420, 1425, 1430, 1435, 1440, and 1445. The hardware configuration 1600 can include a processor 1610, a memory 1620, a storage device 1630, and an input/output device 1640. Each of the components 1610, 1620, 1630, and 1640 can, for example, be interconnected using a system bus 1650. The processor 1610 can be capable of processing instructions for execution within the hardware configuration 1600. In one implementation, the processor 1610 can be a single-threaded processor. In another implementation, the processor 1610 can be a multi-threaded processor. The processor 1610 can be capable of processing instructions stored in the memory 1620 or on the storage device 1630.

The memory 1620 can store information within the hardware configuration 1600. In one implementation, the memory 1620 can be a computer-readable medium. In one implementation, the memory 1620 can be a volatile memory unit. In another implementation, the memory 1620 can be a non-volatile memory unit.

In some implementations, the storage device 1630 can be capable of providing mass storage for the hardware configuration 1600. In one implementation, the storage device 1630 can be a computer-readable medium. In various different implementations, the storage device 1630 can, for example, include a hard disk device/drive, an optical disk device, flash memory or some other large capacity storage device. In other implementations, the storage device 1630 can be a device external to the hardware configuration 1600. The input/output device 1640 provides input/output operations for the hardware configuration 1600.

FIG. 17 illustrates a diagram 1700 describing four categories (in addition to the categories described in FIG. 4) for terminal certification for terminals, e.g., terminal 320, working within the identity, payment and access system 100. The terminals are categorized according to the type of transaction, the credential type, the type of solution provided, deployment model version, whether an ATC update is performed, and the type of certification that is performed. Category 5 terminals provide simple access. Category 6 terminals can be used to provide secure access. Category 7 terminals can be used to provide open transit and Category 8 terminals can be used to provide retail innovation programs.

As mentioned above, Category 5 terminal is provided for simple access. The credential type for this type of system is an access ID or a payment account reference (PAR). In this implementation, combined dynamic data authentication-application cryptogram generation (CDA) is not necessary. Further, the terminal, e.g., terminal 320, reads the access ID or PAR from the EMV card, mobile device or wearable device and provides access. In one implementation, the access ID can be read using a third party data and the PAR can be read via an EMV card or token. In another implementation, third party data can be provided via tag 9F6E and the PAR can be provided via tag 9F24. Access can be provided by matching the access ID or PAR locally or upon verification by a remote access server, e.g., access server 330. The terminal can be provided using a software data kit (SDK), no application transaction counter (ATC) update is required, and the certification requirements for the terminal are low. The terminal SDK can be implemented on a computer operating system or implemented on a mobile device operating system, e.g., for a phone, tablet or similar mobile device.

As mentioned above, Category 6 terminal is provided for secure access systems. Secure access systems can be directed to access and/or identification systems. The credential for this type of system is a hashed PAN and CDA. In this implementation, the terminal, e.g., terminal 320, performs a zero dollar ($0) authorization CDA transaction. The vendor's terminal SDK is an EMV terminal implementing a full EMV access kernel according to access terminal specifications. The full terminal SDK can be based on a contactless reader SDK or implemented in a mobile device operating system, e.g., for a phone, tablet or similar mobile device. In this implementation, ATC updates can be deferred or provided in real-time and certification requirements are medium.

As mentioned above, Category 7 terminal is provided for access and/or transit systems. In particular, the Category 7 terminal is provided for an open transit system. The credential for this type of system is a hashed PAN and CDA. CDA, which is also referred to as combined data authentication, involves including the card decision among the data being signed by the card's RSA key (public key or asymmetric key algorithm). In this implementation, the terminal, e.g., terminal 320, performs a zero dollar ($0) authorization CDA transaction. The vendor's terminal is an EMV terminal implementing full EMV access kernel according to access terminal specifications. In this implementation, ATC updates can be deferred and full certification is required.

As mentioned above, Category 8 terminal is provided for access and/or payment systems. In particular, the Category 8 terminal is provided for retail innovation systems. Retail innovation can be directed to merchant retail stores and/or payments. The credential for this type of system is a hashed PAN and CDA. In this implementation, the terminal, e.g., terminal 320, performs full EMV transactions from the terminal and/or cloud POS SDK. The vendor's terminal can include a terminal SDK implemented on a mobile device running a mobile device operating system or be hosted by a cloud POS server. In this implementation, ATC updates are provided in real-time and full certification is required.

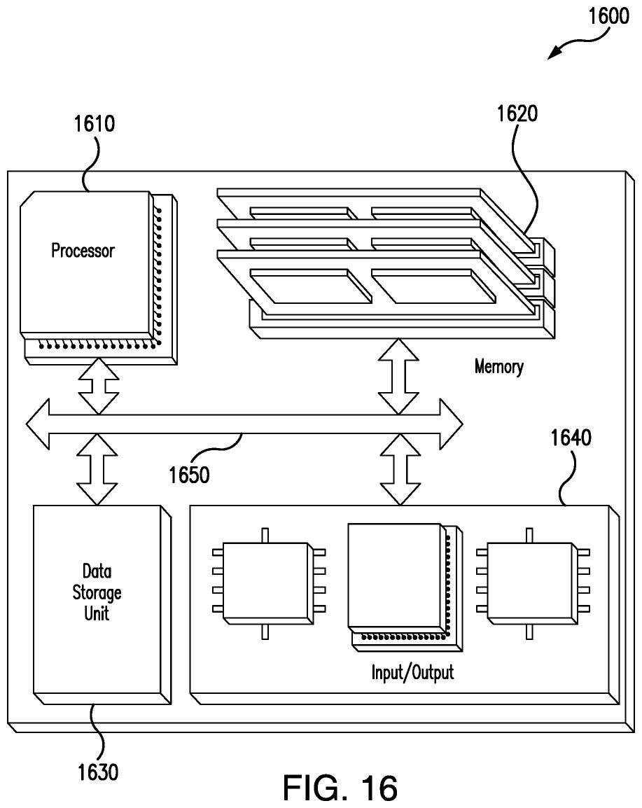

In one implementation, the terminal reads an access ID from third party data (tag 9F6E) by using a SELECT command. In this implementation, a get processing options (GPO) command is not issued. This implementation, while simpler to implement, is less secure and subject to card cloning or emulation. FIG. 18 illustrates an example object 1800 for reading an access ID, e.g., EzAccess ID, from third party data using tag 9F6E.

In one implementation, the terminal performs CDA with a GPO command, which will increase the ATC. In this implementation, the access server sends ATC updates to the issuer. This implementation is more secure and ensures that the card/token is genuine.

In one implementation, the SDK can be implemented via contactless reader or via a Cloud POS server.

FIG. 19 illustrates a diagram of a method 1900 for providing identity, payment and access services. At block 1905, an access ID or PAR is read by the terminal, e.g., terminal 320. The access ID or PAR may be read from a contactless card or via a token provided by a digital wallet present on a mobile device (or accessible via a wearable device communicatively coupled to the mobile device). At block 1910, the terminal determines a transaction result based on the access ID or PAR. In one implementation, the transaction result is determined locally. In another implementation, the transaction result is based on a decision made by an access server, e.g., access server 330. In yet another implementation, the transaction result is determined by performing an offline match of access ID or PAR against a locally stored whitelist. In another implementation, terminal 320 sends the access ID or PAR to a backend server, e.g., a server between access server 330 and the terminal 320, for a decision to be determined and provided by the backend server upon matching the received access ID or PAR against a whitelist. In yet another implementation, the service provider, e.g., the provider of identity, payment and/or access services, can optionally upload, e.g., via a backend server, the transaction data from the terminal (including access ID, PAR and/or other pertinent data) to the access server in real-time or as soon as possible.

The subject matter of this disclosure, and components thereof, can be realized by instructions that upon execution cause one or more processing devices to carry out the processes and functions described above. Such instructions can, for example, comprise interpreted instructions, such as script instructions, e.g., JavaScript or ECMAScript instructions, or executable code, or other instructions stored in a computer readable medium.

Implementations of the subject matter and the functional operations described in this specification can be provided in digital electronic circuitry, or in computer software, firmware, or hardware, including the structures disclosed in this specification and their structural equivalents, or in combinations of one or more of them. Embodiments of the subject matter described in this specification can be implemented as one or more computer program products, i.e., one or more modules of computer program instructions encoded on a tangible program carrier for execution by, or to control the operation of, data processing apparatus.

A computer program (also known as a program, software, software application, script, or code) can be written in any form of programming language, including compiled or interpreted languages, or declarative or procedural languages, and it can be deployed in any form, including as a stand-alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification are performed by one or more programmable processors executing one or more computer programs to perform functions by operating on input data and generating output thereby tying the process to a particular machine (e.g., a machine programmed to perform the processes described herein). The processes and logic flows can also be performed by, and apparatus can also be implemented as, special purpose logic circuitry, e.g., an FPGA (field programmable gate array) or an ASIC (application specific integrated circuit).

Computer readable media suitable for storing computer program instructions and data include all forms of non-volatile memory, media and memory devices, including by way of example semiconductor memory devices (e.g., EPROM, EEPROM, and flash memory devices); magnetic disks (e.g., internal hard disks or removable disks); magneto optical disks; and CD ROM and DVD ROM disks. The processor and the memory can be supplemented by, or incorporated in, special purpose logic circuitry.

The discussion above is directed to certain specific implementations. It is to be understood that the discussion above is only for the purpose of enabling a person with ordinary skill in the art to make and use any subject matter defined now or later by the patent “claims” found in any issued patent herein.

It is specifically intended that the claimed invention not be limited to the implementations and illustrations contained herein, but include modified forms of those implementations including portions of the implementations and combinations of elements of different implementations as come within the scope of the following claims. It should be appreciated that in the development of any such actual implementation, as in any engineering or design project, numerous implementation-specific decisions may be made to achieve the developers' specific goals, such as compliance with system-related and business related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure. Nothing in this application is considered critical or essential to the claimed invention unless explicitly indicated as being “critical” or “essential.”

In the above detailed description, numerous specific details were set forth in order to provide a thorough understanding of the present disclosure. However, it will be apparent to one of ordinary skill in the art that the present disclosure may be practiced without these specific details. In other instances, well-known methods, procedures, components, circuits and networks have not been described in detail so as not to unnecessarily obscure aspects of the embodiments.

It will also be understood that, although the terms first, second, etc. may be used herein to describe various elements, these elements should not be limited by these terms. These terms are only used to distinguish one element from another. For example, a first object or step could be termed a second object or step, and, similarly, a second object or step could be termed a first object or step, without departing from the scope of the invention. The first object or step, and the second object or step, are both objects or steps, respectively, but they are not to be considered the same object or step.

The terminology used in the description of the present disclosure herein is for the purpose of describing particular implementations only and is not intended to be limiting of the present disclosure. As used in the description of the present disclosure and the appended claims, the singular forms “a,” “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises” and/or “comprising,” when used in this specification, specify the presence of stated features, integers, steps, operations, elements, and/or components, but do not preclude the presence or addition of one or more other features, integers, steps, operations, elements, components and/or groups thereof.

As used herein, the term “if” may be construed to mean “when” or “upon” or “in response to determining” or “in response to detecting,” depending on the context. Similarly, the phrase “if it is determined” or “if [a stated condition or event] is detected” may be construed to mean “upon determining” or “in response to determining” or “upon detecting [the stated condition or event]” or “in response to detecting [the stated condition or event],” depending on the context. As used herein, the terms “up” and “down”; “upper” and “lower”; “upwardly” and downwardly”; “below” and “above”; and other similar terms indicating relative positions above or below a given point or element may be used in connection with some implementations of various technologies described herein.

While the foregoing is directed to implementations of various techniques described herein, other and further implementations may be devised without departing from the basic scope thereof, which may be determined by the claims that follow. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A method for providing identity, payment and/or access, comprising:
reading a primary account number (PAN) from a card or token;
generating a hashed PAN;
determining a transaction result based on the hashed PAN.

2. The method of claim 1, wherein the transaction result is determined locally.

3. The method of claim 2, wherein the transaction result is determined locally by performing an offline match of the hashed PAN against a locally stored whitelist.

4. The method of claim 1, wherein the transaction result is determined based on a decision made by a backend server.

5. The method of claim 4, wherein the hashed PAN is sent to the backend server and the backend server matches the received hashed PAN against a whitelist.

6. The method of claim 1, wherein the PAN is read from a contactless card.

7. The method of claim 1, wherein the PAN is read via a token provided by a digital wallet present on a mobile device.

8. The method of claim 1, wherein the PAN is read via a token provided by a digital wallet accessible via a wearable device.

9. The method of claim 1, wherein the PAN is read using a select proximity payment system environment (PPSE) command to ensure that PANs from a particular payment processor are read.

10. A method for providing identity, payment and/or access, comprising:
initiating a zero dollar transaction with a card or token;
determining a primary account number (PAN) from information received via the zero dollar transaction;
authenticating the card or token;
generating a hashed PAN; and
determine a transaction result based on the hashed PAN.

11. The method of claim 10, wherein the card or token is authenticated using combined dynamic data authentication-application cryptogram generation (CDA).

12. The method of claim 10, wherein the transaction result is determined locally.

13. The method of claim 12, wherein the transaction result is determined locally by performing an offline match of the hashed PAN against a locally stored whitelist.

14. The method of claim 10, wherein the transaction result is determined based on a decision made by a backend server.

15. The method of claim 14, wherein the hashed PAN is sent to the backend server and the backend server matches the received hashed PAN against a whitelist.

16. The method of claim 10, wherein the transaction data is provided to a server in real-time.

17. The method of claim 10, wherein the transaction data includes application transaction counter (ATC) data.

18. The method of claim 10, wherein the zero dollar transaction is initiated with a contactless card.

19. A method for providing identity, payment and/or access, comprising:
reading an access identifier (ID) or primary account reference (PAR) from a card or token; and
determining a transaction result locally or via a server based on the access ID or PAR.

20. The method of claim 19, wherein the transaction result is determined by matching the access ID or PAR against a whitelist.
